(19) United States
(12) Patent Application Publication
(10) Pub. No.: US 2012/0303481 A1
(43) Pub. Date: Nov. 29, 2012

(54) System and Method for Dynamic Object Mapping

(76) Inventor: Felix LouisN'jai, San Francisco, CA (US)

(21) Appl. No.: 13/480,605

(22) Filed: May 25, 2012

Related U.S. Application Data
(60) Provisional application No. 61/519,602, filed on May 25, 2011.

(51) Int. Cl. G06Q 40/00; G06Q 30/06; G06F 3/048; G06Q 20/22

(52) U.S. Cl. 705/26.8; 705/35; 705/39; 705/27.1; 715/764

(57) ABSTRACT

A system and method for enabling an individual or entity to view and interact with packets of data associated with various individuals or entities, associated various locations, and represented graphically via a map and a set of related data and images. The system also allows individuals or entities to interact with these packets of data and their creators.

### CROSS-REFERENCE TO RELATED APPLICATION

This application claims the benefit of U.S. provisional application Ser. No. 61/519,602, filed May 24, 2011, incorporated herein by reference.

### TECHNICAL FIELD

The disclosed embodiments pertain to dynamic objects, and, more specifically, to enabling individuals to create, map, track, and interact with dynamic objects and their creators.

### BACKGROUND

Social networking applications such as Facebook, Foursquare, and Twitter, enable individuals to store and selectively share personal data, such as identifying information, personal preferences, opinions, comments, pictures, etc. These applications enable individuals to interact via varying devices and varying modalities for whatever the desired reason or purpose. While the present social networking applications enable individuals to associate a physical location with a picture or a comment regarding their actual location(s) and allow this data to be associated with a map, there is need for an application that enables individuals to create, search, view, and interact via mapped dynamic object data. Such an application would enable users to search, view, and interact with individual-posted data that may or may not be real-time, may or may not be associated with a physical location, and that may pertain to a wide range of subjects.

### SUMMARY

The present invention addresses the aforementioned needs by providing system users with an accessible system and a convenient method for creating dynamic objects, associating dynamic objects with physical locations, viewing dynamic objects on a map and in relation to other dynamic objects, interacting with dynamic objects, and/or interacting with the creators of dynamic objects.

### BRIEF DESCRIPTION OF THE DRAWINGS

In order to describe the manner in which the above-recited and other advantages and features of the invention may be obtained, a more particular description of the invention briefly described above will be rendered by reference to specific embodiments thereof that are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 depicts an exemplary component architecture of a dynamic object management system;

FIG. 2 depicts a flowchart of an embodiment of a process of a dynamic object being created in the dynamic object management system;

FIG. 3 depicts a flowchart of an embodiment of a process of searching for dynamic objects; and

FIGS. 4A through 4D depict exemplary screen shots of a user interface for interacting with the dynamic object management system.

### DESCRIPTION OF EMBODIMENTS

Various embodiments of the invention are discussed in detail below. While specific implementations are discussed, it should be understood that this is done for illustration purposes only. A person with ordinary skill in the relevant art will recognize that other components and configurations may be used without parting from the spirit and scope of the invention.

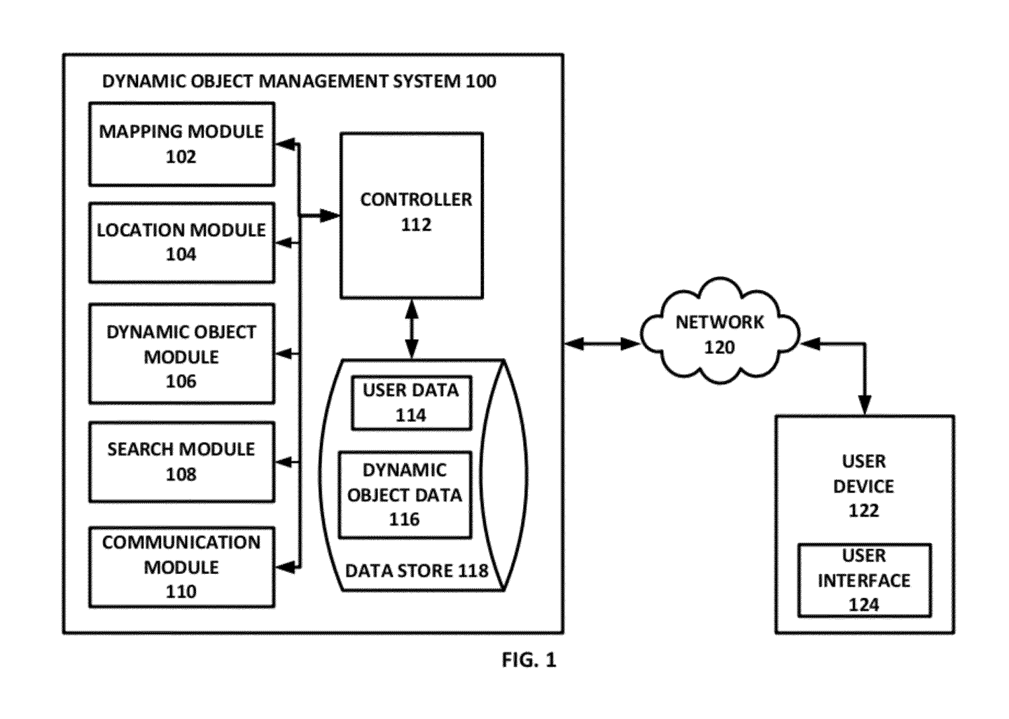

The system depicted by FIG. 1, referred to herein as Dynamic Object Management System 100 (DOM), enables system users (hereon “users”) to create dyamic objects, associate dynamic objects with physical locations, view dynamic objects on a map and in relation to other dynamic objects, interact with dynamic objects, and interact with the creators of dynamic objects. A dynamic object is an electronic packet of data that is created by a user and associated with one or more users and may additionally be associated with one or more physical locations. Dynamic objects may pertain to multiple types of data and may be created to serve as a packet of information tied to a person, a place, an object, and/or an event. A dynamic object may be created to serve as a packet of data tied to a specific location, person, entity, or event; a portal through which users may communicate, interact, gather, advertise, or conduct transactions; or a wormhole through which users can access live broadcasts, programs, networks, and the like. Examples of dynamic objects may include interactive invitations, an individual on the way to work, a bed and breakfast in the Adirondacks through which a user can book and pay for a room, a waterfall in the Amazon, a tagged blue whale in the Arctic, a 100 year old baobab tree, etc. Each dynamic object may include single or multiple signals from any static or dynamic position. For example, with a dyanamic object created by a user on his way to work, he may broadcast his location to DOM 100 via his mobile device during his walk. DOM 100 may then broadcast his location to other interested DOM 100 users, allowing numerous possibilities, such as a bagel shop on his route advertising a deal for him to pick up a bagel breakfast, a co-worker meeting up with him to walk together, etc. In turn, the user may search for dynamic objects for nearby public transportation (e.g., metro wait times, buses en-route, available bike rental stands, etc.) if he gets tired of walking.

Those with ordinary skill in the art will recognize that the logical components set forth in FIG. 1 are merely exemplary and that other configurations that provide substantially similar functionality to that of the logical components in FIG. 1 may be used consistent with the scope of the invention.

DOM 100 may include mapping module 102, location module 104, dynamic module 106, search module 108, communication module 110 and controller 112. Furthermore, DOM 100 may include one or more data stores 118 to maintain user data 114 and dynamic object data 116. Although user data 114 and dynamic object data 116 are depicted in FIG. 1 as being stored separately in data store 118, this is merely illustrative and not to be construed as limited. To enable users to create, search, and view dynamic object data, DOM 100 may interact with one more external components, such user interface 124 and user device 122 via network 120. Network 120 may include the Internet or any other private or proprietary network and may include local area networks (LANs), wireless local area networks (WLANs), wide area networks (WANs), mobile networks, near field communication networks, or the like.

DOM 100 may be a computer mechanism that enables the creation, management, and distribution of dynamic object data. Users, which may be any person, business, or entity, may register with DOM 100 in order to participate in a community of users who provide, search, or access dynamic object data. They may initiate participation in DOM 100 by contacting DOM 100 via a Web site, mail, email, the phone, download of a DOM 100 application or program, or the like. DOM 100 may include controller 112, which may facilitate the routing of data between various, internal components of DOM 100 and/or the routing of data between DOM 100 and one or more external components.

DOM 100 may maintain data associated with users and dynamic objects, such as user data 114 and dynamic object data 116, respectively. For example, such data may be maintained in data tables, system accounts, data stores, or the like. User data 114 may include data associated with users who have employed DOM 100 to create a dynamic object, search existing dynamic objects, view dynamic object data, and/or interact with a dynamic object and/or the user who provided the data to create the dynamic object. For example, user data 114 may include user names, contact information (e.g., mailing addresses, e-mail addresses, phone numbers, chat monikers, etc.), identifying codes (e.g., social security numbers, driver's license numbers, telephone numbers, passcodes, etc.), consumer communication preferences, consumer search parameters, etc. Dynamic object data 116 may include, for example, any variation of data utilized to create a dynamic object.

Although the aforementioned data types are depicted as being maintained by DOM 100, this is not to be construed as limiting. In addition to, or instead of, being maintained by DOM 100, one or more of these data types may be maintained by an external component or plurality of external components.

DOM 100 may include dynamic object module 106, which may be configured to receive dynamic object data and/or user data provided by a user via user device 122 in order to generate dynamic objects. Dynamic object module 106 may additionally be configured to communicate with mapping module 102, location module 104, search module 108, communication module 110, and data store 118 to generate dynamic objects, determine physical locations to associate with dynamic objects, establish interactive maps of dynamic objects, and enable users to communicate with each other via dynamic objects.

Dynamic object module 106 may interact with location module 104 to determine a physical location associated with dynamic object data. Determining a physical location associated with dynamic object data may include utilizing location data specified by a user or determining location data associated with user device 122. For example, a user may provide dynamic object data such as a zip code, an address, a selected point on a map displayed on user device 122, etc. Dynamic object data may also be provided automatically by user device 122 via various types of device tracking methods such as network-based methods, handset-based methods, SIM-based methods, hybrid positioning systems, and the like.

Although some dynamic objects may not be associated with a specific location, DOM 100 includes mapping module 102 to enable users to associate dynamic objects with one or more locations if they so wish. Dynamic object module 106 may interact with mapping module 102 to communicate location data pertaining to one or more dynamic objects so that mapping module 102 may utilize this location data to generate an interactive map display of the physical location pertaining to the received dynamic object data. Although, mapping module 102 is depicted as being a component of DOM 100, such functionally may be provided by a third party mapping resource, such as Google maps, etc.

Dynamic object module 106 may interact with search module 108 to assist in identifying dynamic object data that matches a search request for dynamic object data received from user device 122. Dynamic object module 106 may interact with communication module 110 to enable users to interact with each other via dynamic objects. Such communication may include instant messaging, texting, email, voice over IP, telephone, and the like, and may be initiated via user selection of a link associated with a dynamic object. For example, the dynamic object may include a “send message” link that when clicked enables the user to select to open a chat session, email, call, or otherwise communicate with the dynamic object owner or designated point of contact. Communication module 110 may affect communication directly via DOM 100 or may prompt a third party providing the communication service to initiate the communication. Dynamic object module 106 may also interact with data store 118 for accessing and/or storing user data 114 and dynamic object data 116.

System users may register user data in DOM 100 to ease access to dynamic object data. Users may access DOM 100 via user interface 124, which may be a mobile application, web browser, etc., operating on user device 122, which may be a personal device, such as a personal computer, a mobile device (e.g., mobile phone, smart phone, personal digital assistant, etc.), a kiosk, a computer, a tablet computer, an interactive sign, a billboard, a Global Positioning System device, and the like. A user may register personal information (e.g., name, mailing address, email address, etc.), demographic information (e.g., age, income level, etc.), one or more user identifiers, payment methods (financial account identifiers, such as credit card numbers, bank account numbers, etc.), user preferences, security parameters and settings, and the like. Such information may be entered by the user or the user may authorize a third party database to be accessed by DOM 100 to retrieve such information on his behalf. For example, the user may provide his login credentials to one or more social networking services, such as Facebook, Foursquare, etc. A user identifier may be any data that may be employed to identify the user throughout DOM 100, such as a financial account number (e.g., a credit card number), a phone number, a driver's license number, biometric data (e.g., a consumer's fingerprint), or the like. Additionally, DOM 100 may assign a user identifier and this assigned identifier may or may not be shared with the user (e.g., it may not be shared if it is used for internal purposes only). A user's registered information may be maintained in a user account which may be referenced by one or more user identifiers. Such data may be stored in data store 118.

System user preferences allow users to control how they interact with DOM 100 and varying aspects of their user data. For example, a user may set preferences that allow him to mark dynamic objects, dynamic object owners, user devices, and/or specific locations as safe. Alternatively, the user may choose an area on a map to designate safe. By marking an object, user, and/or location as safe, the user is giving DOM 100 permission to interact freely on his behalf. For example, DOM 100 may not need additional verification from the user should he request to access his financial account data when corresponding with a dynamic object that is geographically located in a zone that he has marked safe. Were he to attempt to transact in a zone not marked as safe, DOM 100 might prompt him to enter a pass code. Alternatively, were he to attempt to transaction in a zone marked unsafe, DOM 100 may reject the transaction, implement further security checks, initiate contact with the user regarding his attempted transaction, and the like. Another preference a user might want to set is how dynamic object information is displayed via user device 122. Such a preference may be user set but might alternatively be deduced via the user's interaction history with DOM 100. Implementing this preference may be automatic and entail displaying certain categories of dynamic objects more prominently than others, not displaying categories of dynamic objects that the user may have selected to “delete” from his view, and the like.

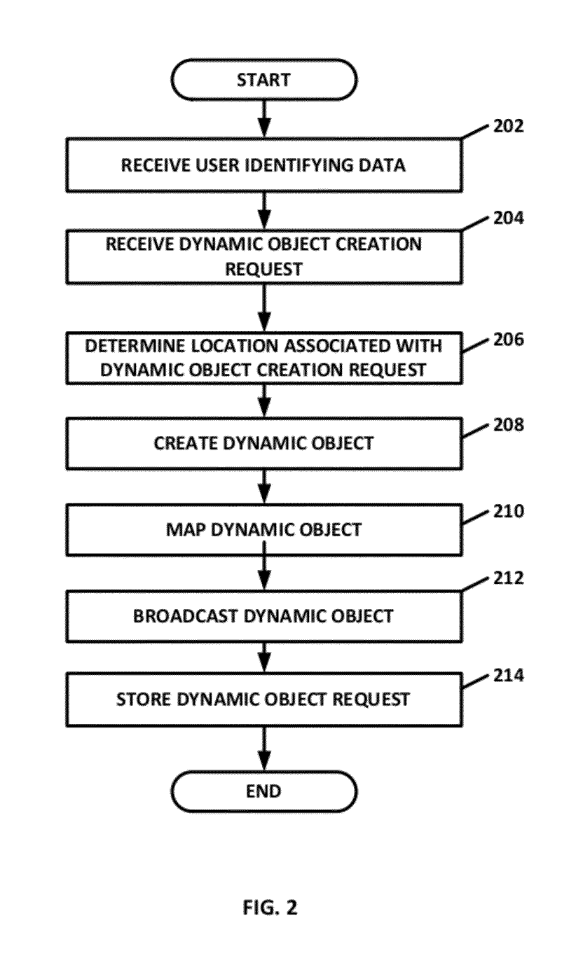

FIG. 2 depicts a flowchart of an embodiment of a process of a dynamic object being created in the dynamic object management system. DOM 100 may receive user identifying data from user device 122 (step 202). This enables DOM 100 to identify the user. Once identified, the user may access user data in data store 118 that is associated with his identifying data. The user may also access any dynamic object data 116 associated with his identifying data, be it dynamic objects that he has created or dynamic objects created by other users but linked to his or his identifying data in some manner. Should the user wish to create a new dynamic object, DOM 100 receives a dynamic object creation request from user device 122 (step 204). The received dynamic object data may include any data that the user wants to associate with the dynamic object. Such data may depend on the type of dynamic object the user wishes to create. Examples of dynamic object data may include a title, a category, a location, a time, a description, an image, a dynamic object expiration date, a link, an embedded video file, an embedded audio file, dynamic object display preferences (i.e., which users can view the dynamic object data, what data users can view, etc.) and data pertaining to an individual that provided the data pertaining to the dynamic object. Dynamic object data may also include an indication of a time interval by which the dynamic object module communicates with the location module to determine if the physical location associated with the dynamic object has changed.

For creating a dynamic object to serve as a packet of data tied to a specific location, person, entity, or event, the user may present any information he wishes, such as a location, a date, a time, a title, a description, and an indication of whether or not the dynamic object is to be public or private (i.e., shared with other users or not). For example, if the user would like to create a dynamic object to advertise that he has an item to sell, he would create a dynamic object describing the object, its price, its availability, its location, and its condition. The user may add additional detail, such as an image, a category, a link, etc. If the user does not provide a category for the dynamic object, DOM 100 may prompt him to do so. Alternatively, DOM 100 may review the data presented by the user and select a category to associate with the dynamic object. Such categories may include but are not limited to trending, food, boutiques, parties, happy hour, music, entertainment, events, for sale, housing, jobs, dating, meet-ups, sports, community, lost and found, shopping, people, media, and places. DOM 100 may also prompt the user to decide if he would like to share the dynamic object he is requesting to create with other users. Such sharing may serve as an announcement that the dynamic object has been created, may include details pertaining to the dynamic object, and a link to the dynamic object, and may occur via email, text message, social media accounts, and the like. If the user has registered with DOM 100 via a social media account, his object data may be automatically or selectively shared with his contacts associated with this social media account. For example, if the user has chosen to share his Facebook information with DOM 100, an automatic message may be generated on behalf of the user to post a message to the user's Facebook profile about the dynamic object he has just created. This would enable his Facebook contacts to see selective details about the dynamic object and may provide a link to the object, enabling his contacts to access it directly. If the user has registered other social media account data with DOM 100, he may be prompted to select those with which he would like to share his dynamic object data.

In addition or alternatively, a user may create a dynamic object that serves as a portal through which he and other users may communicate, interact, gather, advertise, or conduct transactions. Such a dynamic object would include the user selecting from a group of communication mechanisms offered by DOM 100 and the user providing details on the parameters of communication. For example, if the user selects that he prefers text messages about his dynamic objects, he may provide his mobile device information and specify that the system not allow other users to text him about the object during specific hours. This may result in DOM 100 not displaying the communication option to other users during those hours, may disable users of accessing the communication mechanism during those hours, etc. If the user is attempting to sell an item or a service, he may wish to include a shopping mechanism that enables a potential buyer to purchase his offered item or service directly via DOM 100. Such a mechanism may enable users to add dynamic objects to a virtual shopping cart and enable purchase of the items and/or services associated with the dynamic objects via presentation of financial data (e.g., the purchasing user entering his payment account information into user device 122), use of financial data associated with their user data 114, and/or activation of gated actions. A gated action would enable a user to subscribe to automatically purchasing an available item and/or service within specific parameters, such as purchasing from a specified user, at a specified location, at a specified time, etc. For example, a user may indicate to DOM 100 his wishes to utilize his user data 114 to purchase access to a specified location when his device indicates he is in the vicinity of that location, e.g., a club, a toll road, etc. He may further specify that such automated purchase only occur during certain times of the day, with certain financial account data, etc.

Further examples of dynamic objects include those that provide wormholes to enable users with additional interactive functionality. Such wormholes may provide users with sound signals and/or video and sound signals. They may also provide users with access portals to programs, databases, and/or networks. For example, a user may wish to watch a video via his device of a live feed that another user is broadcasting via a dynamic object. By selecting to enter the dynamic object's wormhole, the user's device displays or outputs to an alternate device what the dynamic object owner is capturing live. Wormholes may also enable users to access a dynamic object via multiple user devices. For example, if a dynamic object owner is broadcasting video and audio, a user may wish to access the video from a high quality video device while he accesses the audio from a high quality audio device. In such a case, he may log into DOM 100 via each device and choose the portion of the feed he wishes to access with each device. Should the two devices be accessing the dynamic object via differing networks, DOM 100 may assist to synch the feeds via time delays so that they are presented simultaneously to the user. This type of synching may also occur if a user is attempting to access two different dynamic objects pertaining to a singular subject. For example, if a user wants to view video of a live broadcast of a concert from one dynamic object but wants to hear the audio from a second dynamic object of the same live broadcast, he may request DOM 100 to synch the two broadcasts for delivery via one or more devices. Wormhole enabled dynamic objects may allow users to access and share Internet connectivity among themselves, using an optimizing algorithm to modulate best routing for data packets, taking speed and bandwidth into consideration.

Wormhole enabled dynamic objects may provide users access to a number of platforms, databases, programs, and/or portals of information and networkability. For example, a single dynamic object may serve as a wormhole that enables a user to drop-in to a specified dynamic object and/or location and view associated dynamic objects. Such dynamic objects enable users access to various types of information that might not be accessible via location or category browsing. These associated dynamic objects would be related in some manner (e.g., subject, location, owner, etc.) and may include product listings, live broadcasts, face-to-face chats between two users or amongst multiple users, and the like. Drop-in dynamic objects enable a type of virtual gathering of information related to one, larger dynamic object. For example, a dynamic object may be created for the Super Bowl. A typical dynamic object would allow system users to see information about the Super Bowl, its date and time, the teams involved, a live score feed, etc. However, a drop-in dynamic object for the Super Bowl would include reference and access to all related dynamic objects within specified parameters. For example, a user accessing a drop-in dynamic object might be able to access various other dynamic objects associated with the Super Bowl, such as fan dynamic objects that broadcast live video of the Super Bowl, vendor dynamic objects that sell t-shirts during the game, Super Bowl announcer dynamic objects that enable users to chat live about the game with high profile announcers, fan group dynamic objects through which fans at the game and those accessing the drop-in dynamic object converse in a chat room, etc. As a drop-in dynamic object would give users access to a large body of dynamic object data, the owner may wish to set security parameters, allowing ranges of access to different users based upon the owner's preferences. For example, in the Super Bowl example above, the owner may wish to charge drop-in users a fee to access the announcer objects, may wish to limit the number of live video feeds displayed, may wish to silence certain associated dynamic objects, etc.

Continuing with the process of creating a dynamic object, the location of the dynamic object is determined (Step 206). Dynamic object location may be determined in multiple ways. For example, if the user is accessing DOM 100 via a website, he may right click on a map at the location with which he would like to associate his dynamic object and select to create the object. An address associated with the position on the map at which the user right clicks is communicated to DOM 100. Alternatively, the user may type in an address with which to associate the dynamic object, DOM 100 may automatically detect the user's present location via user device 122 if no location data is provided by the user, or the user may specify that no location is to be associated with the dynamic object.

Once DOM 100 has received the dynamic object data and determined a location to associate with the data (if any), dynamic object module 106 utilizes this data to create the dynamic object (Step 208). If relative and it has not already done so, DOM 100 determines a mapped location to associate with the dynamic object (Step 210). Once the mapped location is determined, DOM 100 broadcasts the dynamic object to other users based on the creating user's preferences (Step 212). If the user has selected to make the dynamic object private, the dynamic object may only be accessible to the creating user. If the user has selected to make the dynamic object public, the dynamic object may be represented on a publically accessible map through which other users can view the dynamic object and access its data. Alternatively, the user may select to share the dynamic object with select users, allowing the object to be broadcast for display in those select system user's DOM 100 generated data. Additionally, the user may indicate users to associate with the dynamic object and/or advertise the availability of other dynamic objects being associated with it for a fee.

DOM 100 stores the dynamic object creation request data (Step 214). This information is stored in association with the creating user data. When the user identifies himself to DOM 100, he can access the dynamic object data associated with his account. This enables him to manipulate the dynamic object by editing it, deleting it, associating it with another system user, re-presenting it, and the like.

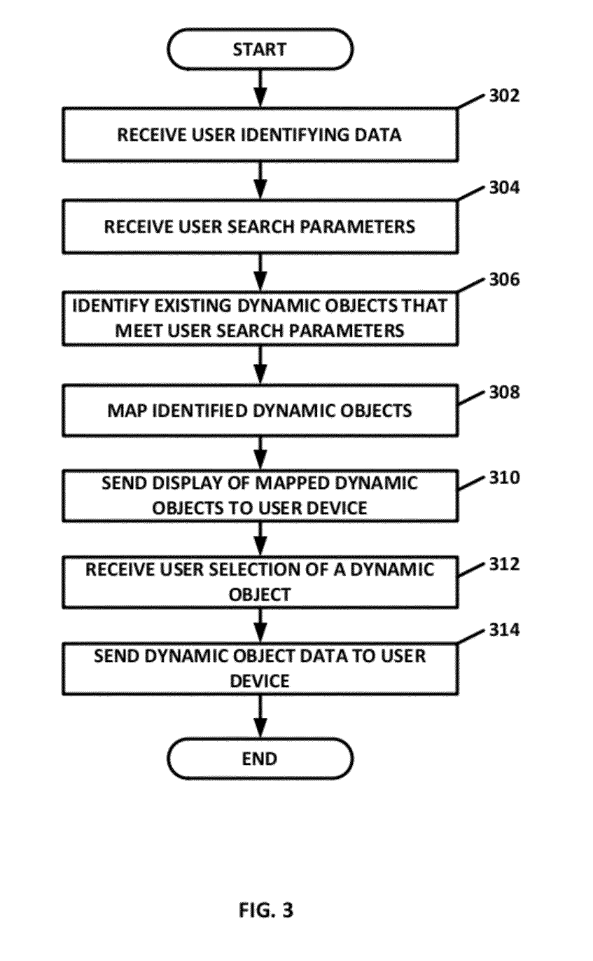

FIG. 3 depicts a flowchart of an embodiment of a process of searching for dynamic objects. DOM 100 may receive user identifying data (Step 302). Identifying data may be any data that the user has previously presented to DOM 100 and has been stored in user data 114 (e.g., name, email address, phone number, passcode, etc.). This enables DOM 100 to identify the user and determine data in data store 118 that is associated with the user. DOM 100 may also receive dynamic object search parameters provided by the user (Step 304). DOM 100 may additionally determine if the user has stored secondary search parameters in user data 114. These secondary search parameters could be added to the received search parameters to further tailor the user's requested search. DOM 100 may utilize search module 108 to identify existing dynamic objects that meet the user's provided search parameters (Step 306). Once the potentially matching dynamic objects are identified, DOM 100 may retrieve dynamic object data 116 associated with the determined dynamic objects and communicate the associated dynamic object data to mapping module 102. Mapping module 102 may generate a map of the associated dynamic object data (Step 308). The generated map may be communicated to system user device 122 so that the system user may review the dynamic object search results according to their mapped locations (Step 310). Should the system user want further data pertaining to a particular dynamic object, DOM 100 may receive a user selection of the dynamic object (Step 312). DOM 100 may access dynamic object data 116 according to the user selection and send the accessed dynamic object data to user device 122 (Step 314). The user may further interact with the dynamic object, as desired, or may return to the generated map to select an alternate dynamic object to view. Example interactions with the dynamic object may include the user providing a review of the dynamic object, communicating with the creating user, sending notification to other users of the dynamic object, adding further data to the dynamic object via uploading additional pictures and/or content, etc.

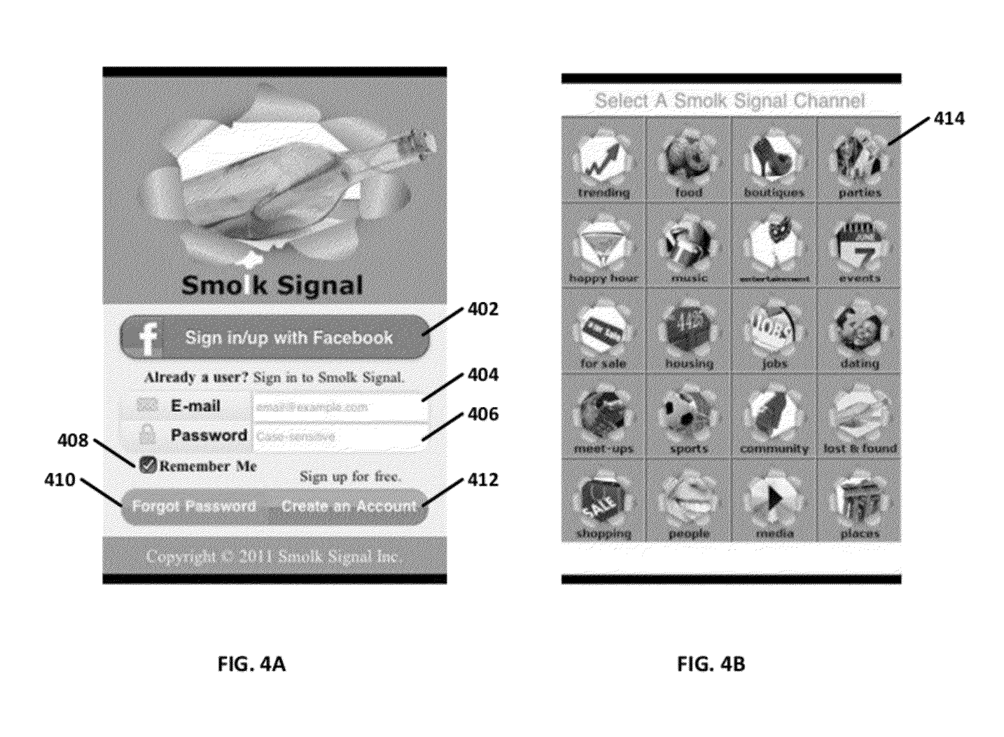

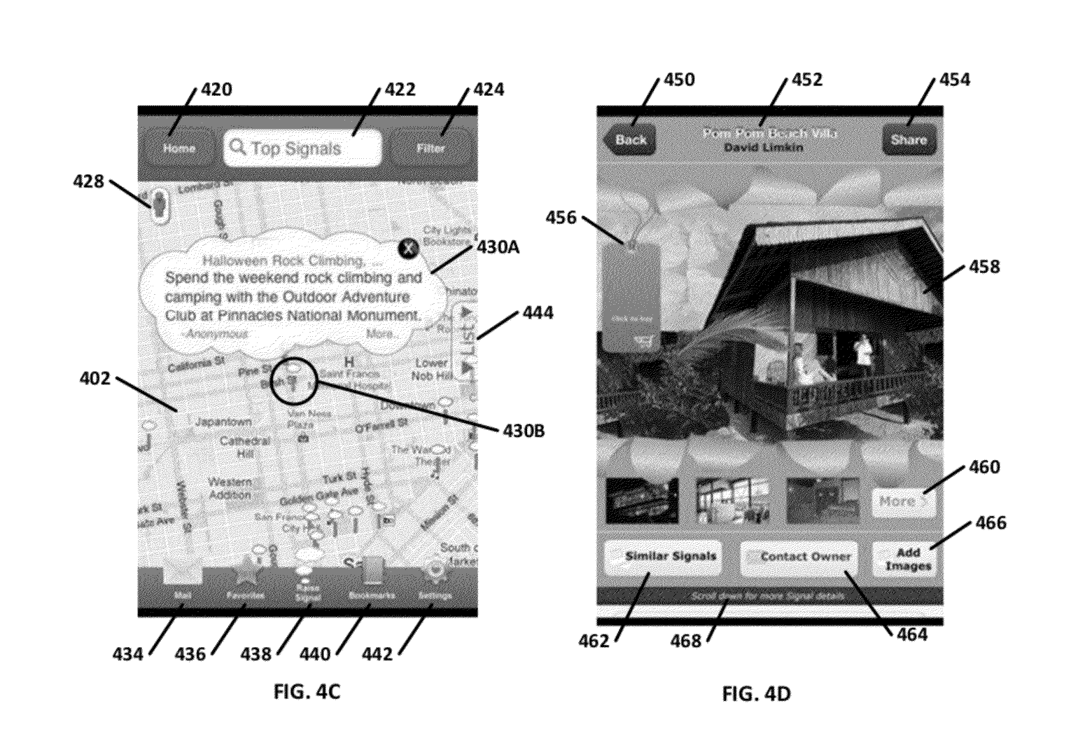

FIGS. 4A through 4D depict examples of screens that may be included in user interface 124 which operates on user device 122 and is used to enable the previously described functions. Although FIGS. 4A through 4D depict example screens that may be suited best for an interface that would be used on a mobile device, such depiction is merely illustrative and is not to be construed as limiting. User interface 124 may be configured to suite any user device 122 the user chooses. It is also to be understood that the data elements included herein are but examples of data elements that may be included within user interface 124.

FIG. 4A depicts an example of a log in screen displayed on user interface 124 that enables the user to enter his identifying data at one or more of fields 404 and 406. The identification data that is requested of the user in the depicted example is the user's email address and his password. These data requests are illustrative and are not to be construed as limiting. Alternatively, if the user has tied his DOM 100 data to a Facebook account, he can choose to sign in by clicking the “sign in/up with Facebook” button 402. If the user has not previously registered with DOM 100, he may chose to do so by clicking on the “sign in/up with Facebook” 402 or by entering a desired email in field 404, entering a desired password in field 406, and by clicking on “Create an Account” 412. If the user has registered with DOM 100 but has forgotten his password, he may enter his email address into field 404 and click on “Forgot Password” 410. A user may also check field 408 to indicate that he would like interface 124 to save his credentials and automatically enter them for him on future use via interface 124.

FIG. 4B depicts an example of a category selection screen displayed on user interface 124. The category selection screen enables the user to select a category of dynamic objects to browse or search. As depicted in FIG. 4B, such categories may include, but are not limited to, trending, food, boutiques, parties, happy hour, music entertainment, events, for sale, housing, jobs dating, meet-ups, sports, community, lost and found, shopping, people media, and places. Alternatively, a user may select to view all categories of dynamic objects.

FIG. 4C depicts an example of dynamic object data displayed via user interface 124 and an example screen of how the display referenced in step 310 of FIG. 3 may be configured. The dynamic object data screen enables a user to view the details of a dynamic object. The present example displays dynamic object data in relation to its associated physical location, but such a display should not be considered limiting. Dynamic object data may also be presented in a list, a diagram, a timeline, or any other manner of presenting data. Dynamic object data display 4C may be the result of the user searching for dynamic objects or browsing dynamic objects via location, category, or both location and category. The user may view dynamic object data 430 A by selecting dynamic object icon 432. The user may select dynamic object icon 432 by clicking on it, hovering over it, etc., and dynamic object data 430A may pop up as a display over map view 426, may be displayed via a separate screen, may be displayed as a list by the user selecting list icon 444, may be audibly announced via user device 122, and the like. There may be multiple other dynamic object icons proximate to dynamic object icon 432. Should the user wish to view the dynamic object data associated with one or more of these other dynamic object icons, he selects it. Should the user want additional information about dynamic object data 430A, he clicks on “more” link 430B.

Other aspects of dynamic object data display 4C may include “Home” button 420, search entry field 422, “Filter” button 424, street view button 428, “Mail” button 434, “Favorites” button 436, “Raise Signal” button 438, “Bookmarks” button 440, and “Settings” button 442. Home button 420 may enable the user to return to the screen that he has designated as his preferred main screen and to which user interface 124 may default upon user log in to DOM 100. Search entry field 422 may enable the user to enter search criteria for identifying dynamic objects that may be of interest. Filter button 424 may enable the user to sort dynamic object data according to specific parameters, such as location, user association, date, etc. Street view button 428 may enable the user to view a street level depiction of a select address on map view 426. Such street level depiction may be provided by DOM 100 or by a third party, such as Google maps. Mail button 424 may enable the user to view communication that he has received via DOM 100. Favorites button 436 may enable the user to view dynamic objects that he has marked as favorites. These may be displayed in a list, a map view, etc., and may be interactive, allowing the user to click on a preferred entry to retrieve details of his selected dynamic object. Raise signal button 438 may enable the user to submit a request to initiate the creation of a dynamic object as illustrated in FIG. 2. Bookmarks button 440 may enable the user to view dynamic objects that he has marked for easy relocation. Settings button 442 may enable the user to review and edit his stored settings for interacting with DOM 100.

FIG. 4D depicts an example of dynamic object data that may be displayed when the user selects “more” link 430B and an example screen of how dynamic object data sent to user device 122 in step 314 of FIG. 3 may be displayed. This data may pertain to dynamic object data 430A and may include “Back” button 450, Title and creating user data 452, “Share” button 454, special object field 456, graphic details 458 and 460, “similar signals” button 462, “contact owner” button 462, “add images” button 466, and instructions for further detail 468.

Title and creating user data 452 pertains to the title of the dynamic object and the user who created it. In this case, the dynamic object title is “Pom Pom Beach Villa” and the user who created it is “David Limkin.” Graphic detail 458 is a picture that the creating user has associated with the dynamic object. The user viewing the dynamic object data may select graphic detail 460 to view additional graphic detail. Graphic detail 460 may provide multiple images associated with the dynamic object and may include a “more” button that the viewing user may click to obtain even more images associated with the dynamic object. Similar signals button 462 may enable the user to view other dynamic object data that has similar characteristics to the one he is currently viewing. Contact Owner button 464 may enable the user to communicate with the user who created the dynamic object, in this case David Limkin. Such communication may be via email, text, voice mail, video chat, etc. The type of communication utilized may be selected by creating user David Limkin, the viewing user, or both. Add images button 466 may enable the viewing user to add other images to graphic detail 460. Back button 450 may enable the user to return to the previous screen he was viewing. Share button 454 may enable the user to share data about the dynamic object with his friends via his chosen method, such as via email, a text, a phone call, social network site, etc.

The dynamic data screen represented in FIG. 4D may additionally include other elements, such as special object field 456, which is depicted in FIG. 4D as a shopping cart button that the viewing user may click on in order to initiate a financial transaction associated with the dynamic object. Special object field 456 may be any number of other objects, such as a link to an external website, a video associated with the dynamic object, a wormhole allowing the user to access a live event, etc. Although special object field 456 is depicted as a single object, it may alternately include multiple objects.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention. Therefore, the above description should not be considered to be exclusive of these other embodiments. Also, it is to be understood that the phraseology and terminology employed herein are for the purposes of description and should not be regarded as limiting.

Terminology used in the foregoing description is for the purpose of describing the particular versions or embodiments only, and is not intended to limit the scope of the present invention that will be limited only by the appended embodiments. As used herein and in the appended embodiments, the singular forms “a,” “an,” and “the” include plural references unless the context clearly dictates otherwise. Similarly, the words “include,” “includes” and “including” when used herein shall be deemed in each case to be followed by the words “without limitation.” Unless defined otherwise herein, all technical and scientific terms used herein have the same meanings as commonly understood by one of ordinary skill in the art. All publications mentioned herein are incorporated by reference. Nothing herein is to he construed as an admission that the embodiments disclosed herein are not entitled to antedate such disclosure by virtue of prior invention. Thus, various modifications, additions and substitutions and the like may be made without departing from the spirit of the invention and these are therefore considered to be within the scope of the invention as defined in the following embodiments.

What is claimed is:

1. A system for creating a display of dynamic objects, comprising:
a controller configured to manage the system;
a data store configured to store data pertaining to one or more of a user and a dynamic object;
a searching module configured to search the data store according to a request received from the user to view data pertaining to the dynamic object; and
a dynamic object module configured to:
receive data pertaining to creating the dynamic object from the controller; and
generate the dynamic object according to the received data.

2. The system of claim 1, comprising:
a mapping module configured to generate an interactive map display, wherein the map display at least displays data pertaining to the dynamic object;
a location module configured to determine the physical location of one or more of the individual and the dynamic object; and
wherein the dynamic object module is further configured to:
communicate with the location module to determine a physical location to associate with the dynamic object;
generate the dynamic object according to the determined physical location; and
communicate with the mapping module to create a mapped entry pertaining to the dynamic object on the interactive map display.

3. The system of claim 1, comprising a communication module that enables a second user to communicate with the user about the dynamic object.

4. The system of claim 3, wherein communication is established between the user and the second user via one or more of an email, a text, a chat, or a phone call.

5. The system of claim 1, wherein the data pertaining to the user includes one or more of a name, a nickname, an email address, a phone number, an address, financial account data, security settings, preferences, and a passcode.

6. The system of claim 5, wherein the financial account data comprises one or more of a bank account number, a credit card number, a debit card number, a stored value account number, and a third party account number to which the user can add charges.

7. The system of claim 5, wherein the security settings comprise one or more of a trusted location and a trusted device.

8. The system of claim 5, wherein the preferences comprise data pertaining to a virtual gate at which the user has designated the system permission to automatically deduct payment from one or more designated financial account to enable access to the virtual gate.

9. The system of claim 1, wherein the data pertaining to the dynamic object includes one or more of a title, a category, a location, a time, a description, an image, an expiration date, a link, an embedded video file, an embedded audio file, a portal to a program, a portal to a platform, a portal to a database, a portal to a network, and data pertaining to a user that provided the data pertaining to the dynamic object.

10. The system of claim 1, wherein the dynamic object data includes an indication of a time interval by which the dynamic object module communicates with the location module to determine if the physical location associated with the dynamic object has changed.

11. The system of claim 1, wherein the dynamic object comprises:
an offer of a good or a service for sale; and
a shopping cart utility application that enables financial settlement between an user offering to sell and a second user offering to purchase the good or the service.

12. A method for creating a dynamic object, comprising:
receiving, at a dynamic object management system, user identifying data;
receiving, at the dynamic object management system, a request from the user to create a dynamic object, the request including dynamic object data;
determining, at the dynamic object management system and based on the dynamic object data, one or more of a category and a location to associate with the dynamic object; and
storing, at the dynamic object management system, the dynamic object.

13. The method of claim 12, comprising storing the user identifying data, wherein presentation of the stored user identifying data enables the user to create a plurality of dynamic objects.

14. The method of claim 12, wherein the dynamic object data comprises one or more of a date, a location, a time, a title, and a description

15. The method of claim 12, wherein the dynamic object data comprises:
data pertaining to an offer of a good or a service for sale; and
a shopping cart utility application that enables financial settlement between the user offering to sell and a second user offering to purchase the good or the service.

16. A method for displaying dynamic object data, comprising:
receiving, at the dynamic object management system, a request to view one or more dynamic objects from an user device, wherein the request includes user identification data and search parameters for locating the one or more dynamic objects and wherein the search parameters at least include a location;
identifying, via the dynamic object management system, the one or more dynamic objects that satisfy the received search parameters;
generating, via the dynamic object management system, an interactive map display, wherein the display includes a visual representation of the identified dynamic objects;
communicating, via the dynamic object management system, the identified one or more dynamic objects that satisfy the received search parameters interactive map display to the user device;
receiving, at the dynamic object management system, indication of a selected dynamic object, wherein the indication signals a request to display the data associated with the selected dynamic object; and
sending, from the dynamic object management system to the user device, the dynamic object data associated with the selected dynamic object.

17. The method of claim 16, wherein the selected dynamic object comprises a drop-in feature enabling the user to do one or more of view one or more dynamic objects associated with the selected dynamic object and access one or more of the dynamic objects associated with the selected dynamic object.

18. The method of claim 16, wherein the one or more dynamic objects associated with the selected dynamic object includes one or more of a wormhole to a live video feed, a wormhole to a live chat session among one or more users, and a wormhole to a collection of products for sale.

19. The method of claim 16, wherein the search parameters include a category.

20. The method of claim 16, comprising formatting, at the dynamic object management system, the dynamic object data associated with the selected dynamic object for displaying the dynamic object data via the user device.

21. The method of claim 16, wherein the user device is one or more of a smart phone, a computer, a tablet computer, an interactive sign, a billboard, and a Global Positioning System device.

22. The method of claim 16, wherein the dynamic object management system enables the user to do one or more of the following:
communicate with the one or more other users;
bookmark one or more dynamic objects;
post a review of one or more dynamic objects;
interact with one or more dynamic objects;
request to follow the activity of the one or more other users;
create a grouping of a plurality of users;
store default search parameters to be applied by the dynamic object management system upon receiving a request to view one or more dynamic objects;
delete one or more dynamic objects;
associate a dynamic object with one or more dynamic object of a second user;
offer one or more of a good and a service for sale via a dynamic object; and
enable other users to purchase via a dynamic object a good or a service offered for sale.
